(19) United States
(12) Patent Application Publication
(10) Pub. No.: US 2023/0377127 A1
(43) Pub. Date: Nov. 23, 2023

(54) NON-DESTRUCTIVE VERIFICATION OF INTEGRATED CIRCUITS

(71) Applicant: Battelle Memorial Institute, Columbus, OH (US)

(72) Inventors: Thomas F. Kent, Columbus, OH (US); Adam G. Kimura, Lewis Center, OH (US); Katie T. Liszewski, Powell, OH (US); Anthony F. George, Columbus, OH (US); Jeffrey A. Simon, Columbus, OH (US); Brian P. Dupaix, Columbus, OH (US)

(21) Appl. No.: 18/198,530

(22) Filed: May 17, 2023

Related U.S. Application Data
(60) Provisional application No. 63/343,204, filed on May 18, 2022.

(51) Int. Cl. G06T 7/00; G06V 10/10; G06V 10/25

(52) U.S. Cl. CPC G06T 7/001; G06V 10/16; G06V 10/25; G06T 2207/30148

(57) ABSTRACT

To validate an integrated circuit (IC), the IC is imaged by scanning an optical beam over the IC to optically inject carriers and measuring an output signal generated by the IC in response to the injected optical carriers. A comparison between the image of the IC and a reference image is computed, and suspect regions of the IC are identified based on the comparison. The reference image may be an image of a reference IC. In another approach, images of training ICs are acquired, and a deep learning algorithm is trained to transform corresponding training IC layouts to the images of the training ICs. The trained deep learning algorithm then transforms a layout of the IC to generate the reference image. The comparison may be computed by computing an error metric for each region corresponding to a standard cell in the reference image.

This application claims the benefit of U.S. Provisional Application No. 63/343,204 filed May 18, 2022 and titled “NON-DESTRUCTIVE VERIFICATION OF INTEGRATED CIRCUITS”, which is incorporated herein by reference in its entirety. This invention was made with government support under contract number FA8650-17-F-1047 awarded by Air Force Research Laboratory (AFRL). The government has certain rights in the invention.

### BACKGROUND

The following relates to the microelectronics arts, integrated circuit (IC) arts, non-destructive IC verification arts, and to like applications.

In a typical process for the design and fabrication of an IC, the functionality of the IC is initially designed using design tools that output a register-transfer level (RTL) representation such as Verilog or VHDL. The RTL description is converted into a netlist description of physically realizable components or circuit elements, called standard cells, and their logical interconnections. The library of standard cells is IC technology-dependent, and typically includes standard cells for physically realizable components or circuit elements such as logic gates (NAND, NOR, et cetera), flip-flops, adders, and so forth. The netlist identifies the standard cells that will make up the IC, and their electronic connections, but it does not specify the placement of these standard cells on the physical IC chip. Further steps design the physical placement of the standard cells on the area of the silicon wafer (or other substrate wafer, e.g. a GaAs wafer), and the physical routing of the electrical interconnects.

This standard cell design approach advantageously enables efficient division of labor. For example, in a typical commercial workflow, a logic designer working for a company (or for a government, military, or the like) designs the IC at the RTL stage, synthesizes the design to the netlist level, and then conducts the placement and routing of the netlist gates and connectivity into the layout. The final layout design can be represented using a standardized format such as a GDSII file format of the layout, which is then sent to a semiconductor foundry that fabricates the design on a silicon (or other) wafer. The final delivered product may be the fabricated IC wafer (which typically has an array of ICs), or IC chips produced by dicing the IC wafer to separate the individual ICs thereby producing the IC chips. In some instances, the foundry may further perform packaging steps on the IC chips and thereby deliver packaged microelectronic devices.

Many microelectronic devices are manufactured by untrusted foundries. Lack of trust could arise because the foundry is a different company, and/or because the foundry is in a foreign country, for example. The lack of observability into these foundries can create a concern for the reliability and trustworthiness of the delivered IC wafers or chips. Some possible concerns include (but are not limited to): substitution of inferior-quality materials or parts in the IC manufacturing; inaccurate implementation of the IC design; malicious insertion of added circuitry; and/or so forth. This reliability and trust problem presents a significant vulnerability in the design and manufacturing life cycle. As such, there is a need to develop post-fabrication verification and validation techniques that address the trust concerns associated with using outsource foundries.

To ensure no counterfeit parts, inaccurate implementation, or modifications such as added circuitry is present, two ways of validating an IC are commonly used: physical validation and functional verification. Each of these can provide a reliable means to ensure the IC matches a reference, but each has some drawbacks. Physical verification involves destructive sample preparation steps including delayering, and imaging of the IC wafer or chip under test (also referred to herein as the IC under test, or as the device-under-test or DUT; this is the IC wafer or chip undergoing verification) and uses a design file (e.g., a GSDII file) of the IC structure for reference. The delayering and imaging procedure is exhaustive, producing hundreds of gigabytes of data to be processed, and destroys the functionality of the original DUT. Functional verification involves collecting data from the DUT during the execution by the DUT of test patterns, and checks for the correct logic flow or verifies second order effect waveforms. Advantageously, functional verification can be non-destructive. However, due to time constraints and the complexity of modern ICs, only a subset of the logic states attainable by the DUT can be verified, which can leave possible vulnerabilities undiscovered. Package level second order effects testing has higher sensitivity because it provides information on how a signal propagates through the DUT. However, the technique entails the generation of a set of golden reference signal signatures, which, due to the complex physical nature of the signal formation, usually must be experimentally determined.

Certain improvements are disclosed herein.

### BRIEF SUMMARY

In accordance with some illustrative embodiments disclosed herein, an integrated circuit (IC) validation method comprises: generating an image of an IC under test by scanning an optical beam over the IC under test to optically inject carriers into the IC under test and measuring an output signal comprising a value, a set of values, or a waveform at each pixel or voxel of the image generated by the IC under test in response to the optical carrier injection; computing a comparison between the image of the IC under test and a reference image; and identifying suspect regions of the IC under test based on the computed comparison. Optionally, the image of the IC under test may be displayed on a display with the suspect regions highlighted in the displayed image of the IC under test. In some embodiments, the method further includes acquiring an image of a reference IC by scanning the optical beam over the reference IC to optically inject carriers into the reference IC and measuring an output signal comprising a value, a set of values, or a waveform at each pixel or voxel generated by the reference IC in response to the optical carrier injection. The image of the reference IC serves as the reference image in these embodiments. In other embodiments, the IC under test is fabricated in accordance with an IC under test layout, and the method further comprises acquiring images of one or more training ICs fabricated in accordance with one or more training IC layouts by scanning the optical beam over the one or more training ICs to optically inject carriers into the one or more training ICs and measuring an output signal comprising a value, a set of values, or a waveform at each pixel or voxel generated by the one or more training ICs in response to the optical carrier injection, training a deep learning algorithm to transform the one or more training IC layouts to the images of the one or more training ICs, and transforming the IC under test layout using the trained deep learning algorithm to generate the reference image. The deep learning algorithm may, for example, comprise a Conditional Generative Adversarial Network (C-GAN). The various layouts may, in some embodiments, be GSDII layouts. In any of the foregoing embodiments, the IC validation method may further comprise identifying regions depicting instances of standard cells in the reference image, and the computing of the comparison in these embodiments suitably comprises computing a difference, similarity, or confidence metric for each of the identified regions. The error metric may, for example, comprise a mean squared error (MSE) or a structural similarity index measure (SSIM). In some embodiments the IC validation method does not include thinning or polishing or removing a substrate of the IC under test. The IC validation method may optionally also include a networking or clustering analysis to learn about the distribution of the cells or some relationship in between. For example, the spatially-resolved data forming the image can be converted into a network representation of the relationship between different cells, and a single number that indicates a confidence in the design can be computed. In some embodiments, the acquired image is not displayed.

In accordance with some illustrative embodiments disclosed herein, the optical beam used in the IC validation method of the immediately preceding paragraph comprises a pulsed optical beam having pulse duration of 900 femtoseconds or lower, and the acquiring of the image of the IC under test includes applying the pulsed optical beam on a backside of a substrate of the IC under test and focusing the pulsed optical beam at a focal point in an active layer disposed on a frontside of the substrate of the IC under test. In these embodiments, a photon energy of the pulsed optical beam is lower than a bandgap of the substrate, and photons of the optical beam are absorbed at the focal point in the active layer of the IC under test by nonlinear optical interactions to inject carriers at the focal point in the active layer.

In accordance with some illustrative embodiments of the IC validation method of either one of the two immediately preceding paragraphs uses a focused optical beam, and the acquiring of the image of the IC under test includes sequentially mechanically positioning a focal point of the focused optical beam at coarse locations of a set of coarse locations in or on the IC under test. With the focal point of the focused optical beam positioned at each coarse location, an image tile is acquired by steering the focal point of the focused optical beam to fine locations of a set of fine locations on or in the IC under test using electronic beam steering of the focused optical beam and, with the focal point of the focused optical beam positioned at each fine location, measuring the output signal generated by the IC under test in response to the optical carrier injection. An electronic processor is programmed to stitch the image tiles together to generate the image of the IC under test.

In accordance with some illustrative embodiments disclosed herein, an IC validation device comprises: means for acquiring an image of an IC under test by scanning an optical beam over the IC under test to optically inject carriers into the IC under test and measuring an output signal comprising a value, a set of values, or a waveform at each pixel or voxel of the image generated by the IC under test in response to the optical carrier injection; means for computing a comparison image between the image of the IC under test and a reference image; and means for identifying suspect regions of the IC under test based on the computed comparison image or metric. The IC validation method may optionally also include a networking or clustering analysis to learn about the distribution of the cells or some relationship in between.

In accordance with some illustrative embodiments disclosed herein, an IC validation device comprises an optical carrier injection imaging system for acquiring an image of an IC under test. The optical carrier injection imaging system is configured to scan an optical beam over an IC under test to optically inject carriers into the IC under test and to measure an output signal comprising a value, a set of values, or a waveform at each pixel or voxel of the image generated by the IC under test in response to the optical carrier injection. The IC validation device further comprises an electronic processor and a display. The electronic processor is programmed to compute a comparison between the image of the IC under test and a reference image and to identify suspect regions of the IC under test based on the computed comparison image. The display is configured to present the image of the IC under test with the suspect regions highlighted in the presented image of the IC under test.

### BRIEF DESCRIPTION OF THE DRAWINGS

Any quantitative dimensions shown in the drawing are to be understood as non-limiting illustrative examples. Unless otherwise indicated, the drawings are not to scale; if any aspect of the drawings is indicated as being to scale, the illustrated scale is to be understood as non-limiting illustrative example.

FIG. 1 diagrammatically illustrates a non-destructive IC verification method performed using the optical carrier injection.

FIG. 2 diagrammatically illustrates an optical carrier injection device.

FIG. 3 diagrammatically illustrates the optical carrier injection by nonlinear optical interaction achieved using the optical carrier injection device of FIG. 2.

FIG. 4 diagrammatically illustrates an IC wafer or chip imaging process suitably performed using the optical carrier injection device of FIG. 2.

FIG. 5 diagrammatically illustrates another embodiment of a non-destructive IC verification method performed using the optical carrier injection.

### DETAILED DESCRIPTION

Disclosed herein are hybrid physical/functional verification techniques that are sensitive to cell-level logic circuitry. The IC verification is performed using optical carrier injection to generate (i) an image of an IC under test, and (ii) an image of a reference IC that serves as the standard against which the IC under test is compared to perform the validation. Optical carrier injection employs an optical beam (typically a laser beam) that is focused on a specific location of an active layer of an IC to excite electron-hole pairs at that location. The excited electron-hole pairs constitute the optically injected carriers. To obtain an image, the optical beam is scanned across the IC wafer or chip can be used to produce an image of the IC. The output signal for such imaging can be an electrical voltage or current or impedance measured across chosen terminals of the IC, reflectivity measurements, or so forth.

In some embodiments, the optical carrier injection can employ conventional linear absorption of the light used to optically inject the carriers. For example, the imaging technique can be scanning optical beam-induced current (OBIC) imaging. For this approach to produce the desired carrier injection, the photon energy of the optical beam is typically higher than the bandgap of the active layer. However, there can be difficulties with performing the optical carrier injection using linear absorption, due to the nature of a typical IC wafer or chip.

In general, an IC wafer or chip includes a substrate that provides the structural support, and an active layer disposed on a frontside of the substrate. The active layer is typically very thin, e.g. a few tens of microns or less in thickness, and hence is usually not self-supporting. The substrate is usually in the form of a wafer or chip that is around 100 microns thick or thicker and provides the structural support for the IC wafer or chip. The “frontside” of the substrate is the side on which the active layer is disposed or fabricated. The active layer may be a single layer, or a stack of layers, possibly including doping features such as n-wells or p-wells, features such as quantum wells or dots, polysilicon layers, and/or so forth. Various metallization traces, insulating layers, and/or the like may be disposed on the active layer, or if the active layer is a stack then metallization trace layers and/or insulating layers may be interspersed amongst the layers of the stack. The substrate also has a “backside” which is opposite from the front side. Because the active layer is fabricated on the front side of the substrate, optical carrier injection in which the optical beam is applied on the frontside (i.e., frontside optical carrier injection) can, in principle, achieve a tight focal point and consequent high spatial resolution for the optical carrier injection. However, in practice frontside optical carrier injection can be adversely affected by metallization traces, insulating layers, or the like which are typically disposed at or near the top of the active layer (i.e., distal from the substrate).

Backside optical carrier injection can be used to optically inject carriers into the active layer while avoiding scattering from the metallization traces or other IC features located at or near the top of the active layer. In this approach, the optical beam is applied on the backside of the substrate and travels through the substrate to reach the active layer disposed on the frontside of the substrate. However, there is a difficulty with backside optical carrier injection. Often, the active layer is fabricated of the same material as the substrate, as is usually the case for mature silicon technologies, or may be fabricated of a material with a higher bandgap than the bandgap of the substrate material. In these cases the bandgap of the substrate is comparable to or smaller than the bandgap of the active layer, and the backside illumination used for optical carrier injection has photon energy higher than the bandgap of the substrate. Hence, the illumination will be significantly attenuated by absorption in the substrate before it can reach and be absorbed by the active layer. To reduce or eliminate this problem, the substrate can be thinned or removed by mechanical, chemical, or mechanochemical processing. However, this is a destructive and time-consuming process, and the resulting IC with thinned or removed substrate can be difficult to handle. Additionally, the substrate thinning or removal can alter the functional behavior of the IC wafer or chip, by mechanisms such as introducing mechanical strain and/or structural defects into the active layer, modifying the thermal heatsinking of the active layer, modifying optical behavior of an optoelectronic IC (if the substrate acts as a light guide, for example), and/or so forth.

To address these difficulties, in some embodiments of the disclosed IC verification, the optical carrier injection utilizes absorption by nonlinear optical interactions, such as two-photon absorption, to inject the electrical charge into the active layer. Advantageously, in this approach the light does not need to have photon energy above the bandgap of the active layer. Furthermore, the nonlinear optical interaction occurs only at high electric field (that is, high light intensity). Hence, optical carrier injection from the backside of the substrate can be performed by using light whose photon energy is below the bandgap of the substrate (and hence is not absorbed by the substrate) and by focusing the light beam at the active layer so that the optical carrier injection occurs at the focus point where the light intensity is highest. In Optical Beam Induced Current (OBIC) imaging using this approach, a spot size of <1 micron can be generated from the nonlinear optical interaction of the laser with the local circuitry of the active layer. In OBIC, this interaction generates a current that is transported to the device pads where it is collected through a measurement system. The collected current is a convolution of the local interactions of the laser at sub-micron resolution, with the transport function of the current to the pads. This OBIC imaging technique using nonlinear optical interaction is more targeted than microscopy or package level testing alone, providing contrast from the spatially resolved current generation and transport information.

Another difficulty with IC validation using imaging employing optical carrier injection is that the imaging can be a time-consuming process, especially if the grid of locations is desired to be dense so as to provide the image at high spatial resolution. Furthermore, limits on the tolerances of the mechanical translation mechanisms of the mechanical translation stage can limit the achievable spatial resolution of the image.

To address this problem, in some embodiments disclosed herein an electronic beam steering device such as a MEMS-based deformable mirror, piezoelectric deformable mirror, galvo mirror, or so forth is used to electronically steer the optical beam to acquire a small region of the image, referred to herein as a two-dimensional (2D) image tile. Acquisition of the image tile is a fast process since it does not use translation of the mechanical translation stage. A coarse array of such image tiles is acquired using the translation stage, preferably with neighboring image tiles overlapping. Finally, the image tiles are combined by stitching together overlapping image tiles to generate an image of the IC wafer or chip. This provides for faster acquisition of a large-area image.

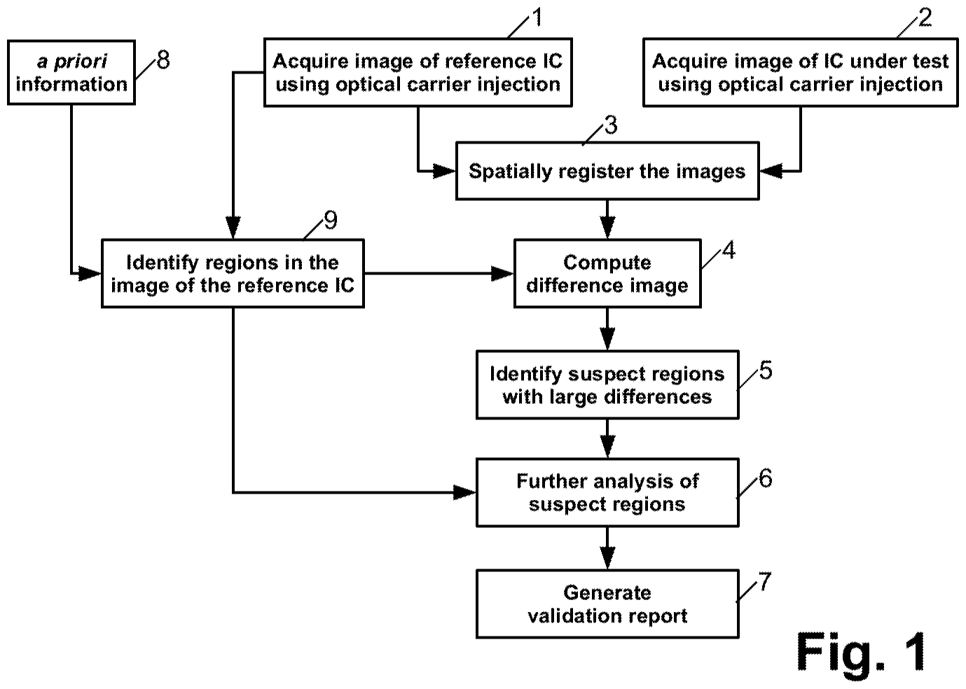

With reference to FIG. 1, in an illustrative IC validation test, an image of a reference IC is acquired using optical carrier injection in an operation 1, and an image of an IC under test is acquired using optical carrier injection in an operation 2. During imaging operation 1 (and likewise for imaging operation 2) the optical beam is scanned over the IC and an output signal produced in response to the optically injected carriers is measured; and the image then consists of a spatial map of the output signal or some derivative of the output signal as a function of the beam position. The imaging operations 1 and 2 are preferably be performed using the same imaging system and using the same or similar imaging parameters, e.g. same or similar image resolution, same or similar imaged area, same or similar optical injection settings (e.g. same or similar laser power, same or similar focus settings, et cetera), same or similar output signal, and so forth. The imaging operations 1 and 2 may employ optical beam-induced current (OBIC) imaging in which the output signal is an electrical signal (e.g. a voltage, current, or impedance) output by the IC in response to the optical carrier injection. In another embodiment, the imaging operations 1 and 2 may employ a reflectivity output in which the output is the reflectivity of a probe light beam that is different from the light beam used to inject the optical carriers. These are merely some illustrative examples of possible output signals for the imaging operations 1 and 2.

The reference IC and the IC under test should be in the same operational state when performing the respective imaging operations 1 and 2. For example, each IC may be in the off state, that is, not connected to any power supply or signal input. Performing OBIC while the device is in the off state provides a way to probe the circuitry without functionality masking potential physical modifications. For example, in any on-state analysis, the signal that is being probed is a function of both the functional activity and the structure. By probing in the off state, a more complete view of structure can be accessed. Probing the off state can also provide information on other aspects of connectivity that is not present when the device is on. For example if a circuit is on, connectivity can be changed by transistors changing states. If it is in the off state, the data reflects a natural or baseline connectivity that Is not affected by whatever program that could be running. Alternatively, each IC may be powered up (i.e., connected to a power supply) but not receiving any signal inputs. In yet another approach, each IC may be powered up and receiving a predefined signal input.

In an optional spatial registration operation 3, the image of the reference IC acquired in the operation 1 and the image of the IC under test acquired in the operation 2 are spatially aligned using a rigid translational or translational-and-rotational alignment, or using nonrigid image alignment. The operation 3 is optional because if the same imaging system is used with the same imaging parameters and with the reference IC and the IC under test positioned in the same way in respective operations 1 and 2 then no spatial registration may be needed.

In an operation 4, a comparison image is computed by taking a comparison between the image of the reference IC acquired in the operation 1 and the image of the IC under test acquired in the operation 2. If the spatial registration operation 3 is performed, then the operation 4 is performed on the spatially registered images. The comparison image may be computed using any suitable comparison metric. In some embodiments, the comparison metric for each pixel or voxel of the comparison image is given by (v_{ref}−vₜₑₛₜ) or, alternatively, by (vₜₑₛₜ−v_{ref}), where v_{ref} is the value of the pixel or voxel in the reference image (acquired in operation 1) and vₜₑₛₜ is the value of the pixel or voxel in the image of the IC under test (acquired in operation 2). This provides a signed difference value, e.g. for the difference metric (vₜₑₛₜ−v_{ref}) positive difference values indicate the signal output for the IC under test is higher than the signal output for the reference IC at that voxel; whereas, a negative difference indicates the signal output for the IC under test is lower than the signal output for the reference IC at that voxel. In other embodiments, the difference metric is a difference-squared metric, in which each pixel or voxel of the comparison image is given by (v_{ref}−vₜₑₛₜ)² where v_{ref} is the value of the pixel or voxel in the reference image (acquired in operation 1) and vₜₑₛₜ is the value of the pixel or voxel in the image of the IC under test (acquired in operation 2). Here the difference metric always outputs a positive value. Other types of comparisons are contemplated, such as structural similarity metric (SSIM) which compares similar images based on qualities such as luminescence, contrast, and structure. Furthermore, the values vₜₑₛₜ and v_{ref} of the respective acquired and reference images could be multi-valued data structures, such as waveforms that are acquired each location. In such a case, the comparison metric is derived from a comparison of signal(s) or waveform(s) at spatially registered locations. The test and reference images in this case have multivalued pixels or voxels, and the comparison between pixels or voxels vₜₑₛₜ and v_{ref} of the respective test image and reference image can use cross-correlation, convolution or other like mathematical functions. The test and reference images with multi-valued pixels or voxels in such embodiments might not be amenable to display without undergoing a suitable rendering process.

In an operation 5, the comparison image is analyzed to identify suspect regions (if any) with large difference values, thus indicating the image of the IC under test deviates significantly from the image of the reference IC in those suspect regions. An optional further analysis operation 6 may be performed to further analyze the suspect regions. For example, it may be possible to identify the source of the deviation in a suspect region based on the magnitude (and sign, if the difference metric outputs a signed difference) of the deviation, and/or based on the distribution or pattern of differences in the suspect region. In an output operation 7, a validation report for the IC under test is generated which identifies the suspect regions and the results of any further analysis performed at optional operation 6. For example, the validation report may include the images of the IC under test and the reference IC with the suspect regions highlighted by a red outline or other highlighting.

The above approach advantageously can be performed without a priori information about the reference IC, such as its circuit architecture. It is only required that the reference IC is a trusted reference, that is, is known to be a reliable and trustworthy representation of the intended structure and functionality of the IC under test. On the other hand, if a priori information about the reference IC is known, such as the IC technology of the IC and/or its GDSII (or other type of) design file, then this information can be leveraged to provide a more informative validation report.

With continuing reference to FIG. 1, a priori information 8 is used in an operation 9 to segment or annotate the image of the reference IC acquired in the operation 1. For example, if the a priori information 8 includes images of standard cells of the IC technology of the reference IC acquired using the same imaging system with the same or similar imaging parameters as are used in the imaging acquisition operations 1 and 2, then the operation 9 can match these standard cell images to regions of the image of the reference IC to identify regions depicting instances of standard cells in the image of the reference IC. For example, the matching of the standard cell images to the regions of the image of the reference IC can employ object recognition and clustering on the image of the reference IC. As another example, if the a priori information 8 includes a GDSII layout design file of the reference IC, then this can be used to identify regions of the image of the reference IC that depict instances of standard cells. In either approach, each instance of a standard cell corresponds to a region of the image of the reference IC (and hence also to a corresponding region of the image of the IC under test that is spatially aligned with the image of the reference IC).

With regions corresponding to instances of standard cells in the reference IC identified, the operation 4 can be modified to compute a difference value for each region identified in the operation 9. For example, in this case the error metric for a region may be computed as a statistically representative error for the region, such as a mean-squared error (MSE) given by

$$\frac{1}{{N}_{R}} {\sum }_{r ∈ R} {( {( {v}_{ref} )}_{r} - {( {v}_{test} )}_{r} )}^{2}$$

where R denotes the region, NR is a count of all pixels or voxels in the region, the notation r E R denotes a pixel or voxel location with coordinates r belonging to the region R (for example, each location r may be a two-dimensional location with Cartesian coordinates x,y if the images are two-dimensional images, or may be a three-dimensional location with Cartesian coordinates x,y,z if the images are three-dimensional images), and (v_{ref})ᵣ is the value of the pixel or voxel at location r in the reference image (acquired in operation 1) and (vₜₑₛₜ)ᵣ is the value of the pixel or voxel at location r in the image of the IC under test (acquired in operation 2).

Instead of using the MSE as the difference metric, a structural similarity index measure (SSIM) can be used as the difference metric. The SSIM compares images based on qualities such as image luminescence, image contrast, and structure, rather than using a pixel by pixel comparison. SSIM provides for versatile image comparisons, accounting for slight variations in a set of images. In one non-limiting illustrative approach, Python, an open source graph analysis and visualization tool, can be used for the SSIM calculation, with clustering algorithms using the Yifan Hu Proportional method and visualization of the clusters implemented in GEPHI. For example, Python can be used for the SSIM and GEPHI for the clustering.

The operation 5 then identifies suspect regions of the IC under test as those regions (if any) corresponding to instances of standard cells in the reference IC for which the MSE computed in operation 4 is higher than some chosen threshold value. The operation 6 preferably includes annotating any suspect region with an identification of the standard cell that is present at that region in the image of the reference IC, and the reporting operation 7 then provides a more informative report which indicates specific standard cell present in the image of the reference IC at each suspect region. If the a priori information 8 includes a GDSII layout design file for the reference IC, then the report may optionally include a graphical depiction of the GDSII layout created from the GDSII design file and the image of the IC under test acquired at operation 2 (and optionally also the image of the reference IC acquired at operation 1), with the suspect regions highlighted in each of these images of the report and labeled as to the standard cell depicted at that suspect region in the image of the reference IC.

As previously noted, the imaging operations 1 and 2 of FIG. 1 employ optical carrier injection to inject carriers into the active region, and the signal output optical may be an induced current (i.e., optical beam-induced current or OBIC imaging). In some embodiments, the absorption of the light to produce the optical carrier injection is by way of linear absorption of light. However, using linear absorption can introduce difficulties such as absorption of the light beam by the substrate. Hence, in some embodiments of the IC verification method of FIG. 1, the imaging operations 1 and 2 utilize optical carrier injection in which the absorption is by nonlinear optical interactions, such as two-photon absorption, to inject the electrical charge into the active layer.

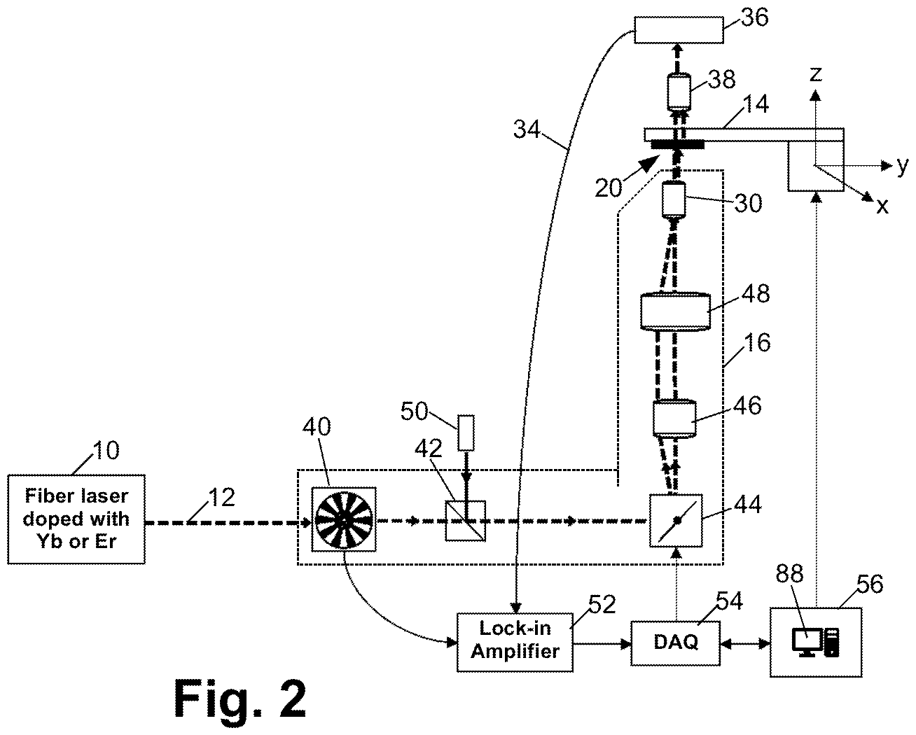

With reference to FIGS. 2-4, an illustrative imaging system is described, which is suitable for performing the imaging operations 1 and 2 and which utilizes optical carrier injection in which the absorption is by nonlinear optical interaction.

With reference to FIG. 2, an optical carrier injection device includes a light source (e.g., an illustrative laser) 10 which outputs a pulsed optical beam 12 (diagrammatically indicated by a dashed line in FIG. 2). A mechanical translation (or, more generally, positioning) stage 14 holds an IC wafer or chip 20 by way of adhesive, a vacuum chuck, sample clips, or the like (details not shown). In another approach, the IC wafer or chip 20 may be mounted on a printed circuit board (PCB) that is in turn mounted to the translation stage 14 by screws or other fasteners. For the operation 1 of FIG. 1 the IC wafer or chip 20 is the reference IC, while for the operation 2 of FIG. 1 the IC wafer or chip 20 is the IC under test. The illustrative mechanical translation stage 14 is a three-axis translation stage providing controllable translation in any of three mutually orthogonal directions labeled (without loss of generality) in FIG. 2 as the x-, y-, and z-directions. An optical train 16 is arranged to apply the pulsed optical beam 12 output by the laser 10 to the IC wafer or chip 20 held by the translation stage 14.

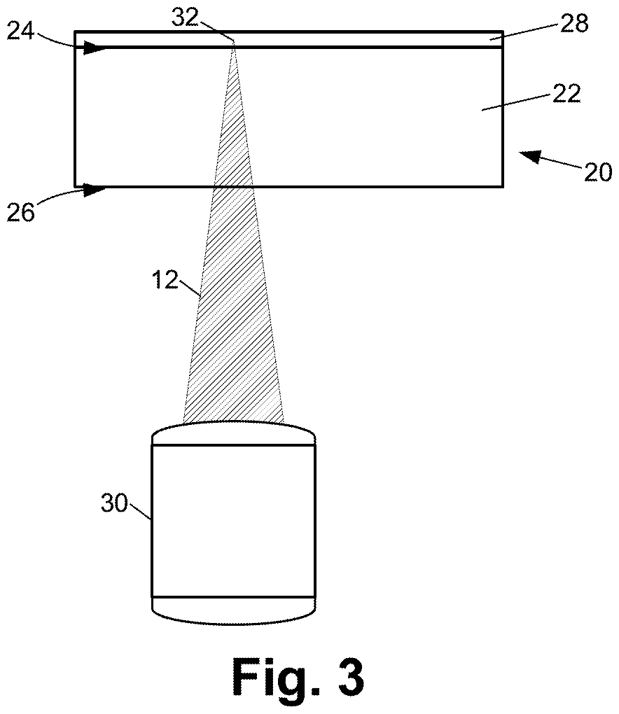

With reference to FIG. 3 an enlarged diagrammatic representation of the IC wafer or chip 20 is shown. The IC wafer or chip 20 includes a substrate 22 having a frontside 24 and a backside 26, and an active layer 28 disposed on the frontside 24 of the substrate 22. In general, the active layer 28 may be disposed on the frontside 24 of the substrate 22 in various ways, depending upon the IC technology that is employed in the reference IC and the IC under test. In the case of some silicon fabrication processes, the active layer 28 is fabricated on the frontside 24 of the substrate 22 by process steps such as ion implantation, dopant diffusion, or so forth that modify the topmost portion of the frontside 24 of the substrate 22 to form the active layer 28. In other silicon fabrication technologies, the active layer 28 may comprise one or more epitaxial silicon layers that are deposited on the frontside 24 by deposition techniques such as vacuum evaporation, sputtering, chemical vapor deposition, or so forth. In a variant approach, one or more of the deposited layers may be of a group IV material that is different from silicon, such as germanium (Ge) or an alloy of silicon and germanium (SiGe). The active layer 28 could additionally or alternatively include one or more deposited layers of a different material type such as a III-V or II-VI compound semiconductor. In the foregoing examples, the substrate 22 is a silicon substrate. However, more generally, the substrate 22 may be made of a different material, such as gallium arsenide (GaAs), indium phosphide (InP), or so forth, as technologies employing these materials are often used for optoelectronic IC wafers or chips. Typically (although not necessarily) the active layer 28 is made of the same material as the substrate 22 or of a compatible similar material. Some examples of the latter include: a SiGe active layer on a silicon substrate; a GaAs active layer on a GaAs substrate; an aluminum gallium arsenide (AlGaAs) active layer on a GaAs substrate; an active layer comprising a stack of alternating GaAs/AlGaAs layers on a GaAs substrate; a lattice-matched InGaAs layer on an InP substrate; and/or so forth. These are merely non-limiting illustrative examples. In the following, and for illustrative purposes only, the substrate 22 is assumed to be a silicon substrate and the active layer 28 is likewise assumed to be a silicon or stack of silicon layers (e.g. with different doping type/levels). Although not shown, it will be appreciated that the IC wafer or chip 22 may include additional features such as metallization traces, electrically insulating layers (e.g., deposited oxide layers and/or silicon oxide layers formed by oxidation of the topmost portion of the frontside 24 of the substrate 22), and/or so forth.

With continuing reference to FIGS. 2 and 3, the optical train 16 includes an objective 30 arranged to focus the pulsed optical beam 12 at a focal point 32 in the active layer 28 disposed on the frontside 24 of the substrate 22. As seen in FIG. 3, the illustrated optical carrier injection thus employs backside optical carrier injection in which the pulsed optical beam 12 passes through the substrate 22 to reach the active layer 28 disposed on the frontside 24 of the substrate 22. As previously noted, backside optical carrier injection has advantages in avoiding interference from the metallization traces or other IC features located at or near the top of the active layer. However, backside optical carrier injection is typically impractical when the bandgap of the substrate is comparable to or smaller than the bandgap of the active layer, because for optical carrier injection the optical beam should have photon energy higher than the bandgap of the substrate, and hence the illumination will be absorbed by the substrate before it can reach and be absorbed by the active layer. This can be addressed thinning or removing the substrate, but as previously noted there are numerous disadvantages that approach.

Various aspects of the disclosed optical carrier injection address this problem by utilizing absorption by nonlinear optical interactions to inject electrical charge into the active layer 28 by way of backside optical carrier injection using the laser (or other light source) 10 that outputs light with photon energy below the bandgap of the substrate 22, and preferably also below the bandgap of the active layer 28. A consequence of the photon energy of the pulsed optical beam 12 being below the bandgap of the substrate 22 is that the beam 12 passes through the substrate 22 with little or no absorption. Hence, the optical carrier injection methods disclosed herein preferably do not include thinning or removing the substrate 22 of the IC wafer or chip 20. Additionally, polishing of the backside 26 of the substrate 22 is typically not required. Typically, the backside is polished in traditional applications employing backside illumination, in order to reduce spurious signals due to scattering. However, for absorption by nonlinear optical interaction(s), the scattering on an optically rough surface does not significantly degrade the resolution because the scattered light is at a too low of intensity to generate nonlinear optical interactions and only would minimally affect the signal.

If only linear absorption were considered, the pulsed optical beam 12 would also pass through the active layer 28 with little or no absorption that results in carrier injection. However, as diagrammatically shown in FIG. 3, the objective 30 operates to focus the pulsed optical beam 30 at the focal point 32 in the active layer 28. This results in high light intensity (and correspondingly high electric field intensity) at the focal point 28 as all the optical energy of the beam 30 is concentrated at the focal point 32. The high electric field can induce absorption by nonlinear optical interaction such as, for example, two-photon absorption (TPA). In nonlinear optical interaction processes such as two-photon absorption, the absorption is typically proportional to the square, cube, or higher order polynomial of the light intensity. The focused beam produces sufficient intensity at the focal point 32 so that a portion of the optical energy of the pulsed optical beam 30 is absorbed by the active layer 28 at the focal point 32 by way of two-photon absorption or other nonlinear optical interaction(s), and this absorbed optical energy is sufficient to (optically) inject carriers into the active layer 28 at the focal point 32.

A challenge with this approach leveraging absorption by nonlinear optical interaction is that the high light intensity at the focal point 32 can result in rapid heating at the focal point 32, due to the optical power being deposited at the focal point 32. This is minimized in the disclosed optical carrier injection techniques by pulsing the optical beam 12 so that each pulse has pulse duration of 900 femtoseconds or lower. In other words, the laser 10 is a femtosecond laser. The pulses are separated by time intervals of sufficient length to allow for heat dissipation between the pulses. For example, the femtosecond laser operates at 50-100 MHz in some non-limiting illustrative embodiments, so that successive femtosecond pulses are spaced apart by time intervals of around 10-20 nanoseconds. Hence, the pulsed optical beam 12 deposits sufficient optical energy in each pulse to produce two-photon absorption or other absorption by nonlinear optical interaction(s), but the (time-averaged) power of the pulsed optical beam 12 is low enough to avoid problematic heating at the focal point 32.

By way of non-limiting illustrative example, if the substrate 22 is a silicon substrate then its bandgap is typically around 1.1 eV, although the precise bandgap energy depends on dopant or impurities type and level. For this case, the photon energy of the pulsed optical beam 12 is preferably 1.0 eV or lower to be below the silicon bandgap. The active layer 28 in this case may be a silicon-based active layer, although an active layer comprising another material is contemplated. Some suitable femtosecond lasers with this photon energy include fiber lasers in which the fiber is doped with ytterbium (Yb) and/or erbium (Er), which can achieve desirable operating parameters for use with a silicon substrate such as pulse duration of 900 femtoseconds (fs) or lower and (average) optical power of 150 milliwatts (mW) or higher. Some suitable femtosecond fiber lasers of this type with photon energy on the order of 1550-1560 nm (photon energy 0.80 eV), pulse frequencies in a range of 50-100 MHz, and average optical power of 150 mW or higher are available from Menlo Systems GmbH, Martinsried, Germany.

The optical carrier injection system is further configured to measure an output signal 34 produced in response to the carriers injected at the focal point 32 by two-photon absorption or absorption by other nonlinear optical interaction process(es). The output signal 34 may, for example, be an electrical signal produced by the IC wafer or chip 20 in response to the carriers injected at the focal point 32 in the active layer 28, or a light output signal produced by recombination of the carriers injected at the focal point 32 in the active layer 28. In the illustrative system of FIG. 2, the output signal 34 is a light output signal that is measured using a photodetector 36 for detecting the light output which is focused on the photodetector 36 by a light output collection objective 38. If the output signal 34 is an electrical signal produced by the IC wafer or chip 20, this may for example be measured as an electrical voltage or current or impedance measured across chosen terminals of the IC wafer or chip 20. (The choice of terminals is suitably based on a priori knowledge of the architecture of the IC wafer or chip 20). In some applications multiple output signals may be measured, such as a light output signal and one or more electrical signals measured across various pairs of terminals of the IC wafer or chip 20.

Conversely, it is noted that the measurement of an output signal is optional; in some embodiments such as optically programming an IC memory by setting specific memory elements to specific charge states, no output signal may be measured.

In addition to the objective 30, the illustrative optical train 16 of FIG. 2 includes a mechanical chopper 40, a beam splitter 42, a galvo mirror 44, an f-theta scan lens 46, and a tube lens 48 that inputs to the objective 30. The beam splitter 42, along with a low power alignment laser 50 emitting visible light (e.g., a red or green helium-neon, i.e. HeNe, laser), are optional components used to align the optical train 16. The chopper 40 operates in conjunction with a lock-in amplifier 52 to provide a high sensitivity detector for detecting the output signal 34. The chopper 40 typically operates at a much lower frequency than the femtosecond laser 10, e.g. in one non-limiting illustrative embodiment the chopper 40 operates at 1 kHz while the femtosecond laser 10 produces the pulsed optical beam 12 with a pulse frequency of 100 MHz. Rather than employing the chopper 40, another type of lock-in amplification can be used, such as radio frequency (RF) lock-in amplification in which the lock-in amplifier 52 uses the RF signal driving the laser 10 as the reference signal.

As noted previously, another problem with optical carrier injection systems, especially when used for imaging, is that it can be a time-consuming process if the grid of locations dense so as to provide the image at high spatial resolution. Furthermore, limits on the tolerances of the mechanical translation mechanisms of the mechanical translation stage can limit the achievable spatial resolution of the image.

To address this problem, the optical carrier injection system of FIG. 2 employs the illustrative galvo mirror 44 (or another electronic beam steering device such as a MEMS-based deformable mirror, piezoelectric deformable mirror, acousto-optic beam steering, electro optic beam steering) to electronically steer the pulsed optical beam 12 to acquire a small region of the image, referred to herein as a two-dimensional (2D) image tile. In the illustrative system of FIG. 2, the beam steering device 44 is a galvo mirror, and the f-theta scan lens 46 corrects for the angular deflection of the pulsed optical beam 12 introduced by the galvo mirror 44. The lateral movement of the beam is thus determined by the angle of the galvo mirror 44 and the spacing between the galvo mirror 44 and the f-theta scan lens 46.

With the focal point 32 of the focused optical beam 12 positioned at a coarse location arrived at by operation of the mechanical translation stage 14, a 2D image tile is acquired by: (i) steering the focal point 32 of the focused optical beam 12 to fine locations of a 2D set of fine locations on or in the IC wafer or chip 20 using electronic beam steering (via the galvo mirror 44 or other electronic beam steering device); and (ii) with the focal point of the focused optical beam positioned at each fine location, acquiring the output signal 34 produced in response to an electrical charge that is optically injected into the IC wafer or chip 20 at the fine location by the focused optical beam 12. In the illustrative embodiment of FIG. 2, digital acquisition hardware (DAQ) 54 is used to control the galvo mirror 44 (or other electronic beam steering device) to perform the steering (i) and the output signal acquisition (ii), the latter being performed in conjunction with the lock-in amplifier 52 used with a reference signal derived from the chopping performed by the mechanical chopper 40 (or, alternatively, using RF lock-in amplification with the RF signal driving the laser 10 as the reference) to provide good noise rejection. In some illustrative embodiments, a DAQ from National Instruments Corporation (Austin, Texas, USA) is used as the DAQ 54. The overall image acquisition is controlled by a computer 56 that controls the DAQ 54 to control image tile acquisition and to receive the acquired image tiles, and the computer 56 controls the mechanical translation stage 14 to sequentially mechanically position the focal point 32 of the focused optical beam 12 at coarse locations of a set of coarse locations in or on the IC wafer or chip 20. While the 2D image tile is a two-dimensional image, if the translation stage 14 is a three-dimensional (3D) translation stage (as illustrated in FIG. 2), then the set of coarse locations may be a 2D array of coarse locations providing a final image that is 2D; or, the set of coarse locations may be a 3D array of coarse locations providing a final image that is 3D (i.e., volumetric) albeit with coarse resolution in the depth (z) direction determined by the spacing of the coarse locations along the z-direction.

The computer 56 is programmed by suitable software to combine the 2D image tiles. To provide smooth image content at the tile boundaries, neighboring image tiles preferably overlap (for example, achieved by setting the spacing between adjacent coarse locations to be smaller than the size of the image tiles) and the image tiles are combined by stitching together overlapping 2D image tiles to generate an image of the IC wafer or chip 20. In one non-limiting illustrative approach, the computer 56 is programmed to perform the image stitching by executing pairwise and/or grid/collection stitching plugins of the ImageJ image processing suite (available at imagej.net and github.com/imagej/imagej1).

While the illustrative embodiment of FIG. 2 employs the DAQ 54 and computer 56 for control and processing of the image acquisition, more generally these control and processing operations can be performed by an electronic processor. The electronic processor 54, 56 may comprise a computer that directly controls both the stage 14 and galvo mirror 44 and is connected to receive the signal output from the lock-in amplifier 52; or may comprise the illustrated combination of a DAQ 54 and computer 56; or may comprise a specially-constructed microprocessor- or microcontroller- or FPGA-based controller; or may comprise a cloud-based server computer; or may comprise various combinations thereof; and/or so forth.

An optical carrier injection system of the configuration shown in FIG. 2 was actually constructed and tested. The system employed a Menlo Systems 1550-1560 nm Yb:fiber laser with 100 fs pulses, operating at a pulse rate of 100 MHz and (average) optical power of 300 mW. A galvo mirror was used as the electronic beam steering device 44, with scan parameters 3-degrees by 3-degrees scan range with 0.5-20 ms/deg dwell. The objective 30 was a 10× to 100× objective, depending on the desired imaging magnification, and the mechanical translation stage 14 was operated to acquire a two-dimensional 7×7 grid of coarse locations with 0.75 mm/step size (4.5 mm scan dimension), or other grid and step size combination depending on the desired image dimensions. The chopper 40 was operated at 1-5 kHz and the lock-in amplifier 52 operated in a current input mode in the picoampere (pA) range with a 1 ms to 3 ms time constant. In other experiments, RF lock-in amplification was used, with the reference signal being the 100 MHz RF signal driving the laser 10. For imaging tasks, the image tiles were stitched together using the Fiji open source implementation of ImageJ (Fiji is an acronym for “Fiji Is Just ImageJ”). It is to be appreciated that these are merely illustrative values used in experiments, and that other values and value combinations for these various parameters are expected to be suitable depending on the specific hardware and the optical carrier injection task being performed.

In another experiment, imaging by optical carrier injection was performed on a commercially available 8-bit microcontroller IC. In this case, the image is an optical beam-induced current (OBIC) image in which the output 34 was electrical voltage across the power terminals, measured in microvolts (N). The image obtained using the system of FIG. 2 provides both high spatial resolution and good image contrast.

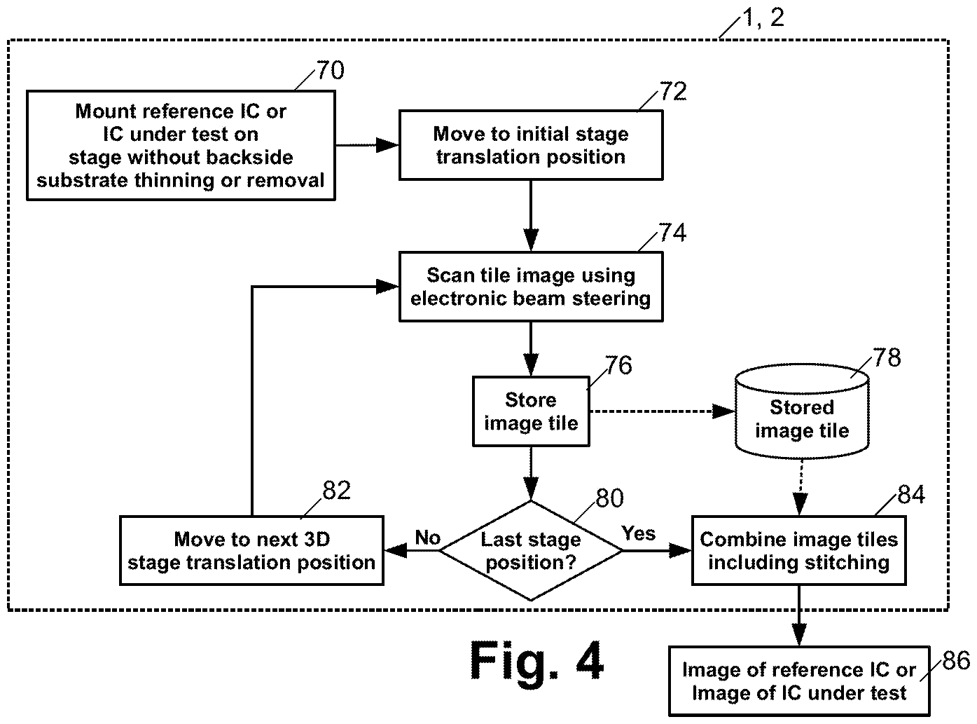

With reference to FIG. 4, an imaging method suitably performed by the optical carrier injection system of FIGS. 2 and 3 is shown by way of a flowchart. The imaging method of FIG. 4 may be used to perform the imaging operation 1 of FIG. 1—in this case the IC wafer or chip 20 is the reference IC. The imaging method of FIG. 4 may also be used to perform the imaging operation 2 of FIG. 1—in this case the IC wafer or chip 20 is the IC under test. In an operation 70, the IC wafer or chip 20 (e.g., reference IC or IC under test) is mounted on the mechanical translation stage 14. Preferably, the mounting operation 70 does not include thinning or removing or polishing the substrate 22 of the IC wafer or chip 20. In an operation 72, the mechanical translation stage 14 is operated to move to the initial 2D or 3D stage translation position (2D or 3D depending on whether the stage 14 includes z-direction “depth” movement, and if so whether the set of coarse points is 2D or 3D). In an operation 74, the electronic beam steering device 44 scans the image tile at the current stage translation position (i.e. current coarse location). More particularly, in the operation 74 the beam steering device 44 is operated to steer the focal point 32 of the focused optical beam 12 to fine locations of a 2D set of fine locations on or in the IC wafer or chip 20 and, at each fine location, the output signal 34 produced in response to an electrical charge that is optically injected into the IC wafer or chip 20 at the fine location by the focused optical beam 12 is measured. In illustrative FIG. 2, the beam steering device 44 is the illustrative galvo mirror 44 which provides electromechanical beam steering. In other embodiments, the beam steering device may employ electro-optical modulation which can provide higher speed electronic beam steering. Typically, the set of fine locations defines a two-dimensional grid of fine locations in the x-y plane. In an operation 76, the acquired image tile is stored in a storage 78 (e.g., flash memory, solid-state drive, magnetic disk, random-access memory or RAM, et cetera). At a decision 80 it is determined whether this is the last coarse location to be imaged. If not, then flow passes to operation 82 at which the mechanical translation stage 14 is operated to move to the next stage translation position (that is, the next coarse location), and the operations 74, 76, 80 are thus repeated until the image tiles corresponding to all coarse locations of the set of coarse locations are acquired. Typically, the set of coarse locations forms a 2D grid in the x-y plane, or a 3D grid over in x-y-z space.

When the image tile for the last coarse location has been acquired and stored, the decision 80 transfers flow to an operation 84 which combines the image tiles, including stitching together the image tiles, to generate the image 86 of the reference IC or the IC under test (depending on which was mounted at operation 70). For example, the stitching may employ Fiji or another implementation of ImageJ. The image 86 of the reference IC or the IC under test then serves as input to the subsequent operations of FIG. 1.

In some embodiments, the computer 56 of the imaging system of FIG. 2 may also be programmed to perform computational operations 3, 4, 5, 6, 7, and 9 of the validation method of FIG. 1, so that the system of FIG. 1 can be used to perform the validation method of FIG. 1. In some such embodiments, the validation report generated at the operation 7 may be displayed on a display 88 of the computer 56, including for example displaying the image of the IC under test acquired in the operation 2 optionally along with one or both of (i) the image of the reference IC acquired in the operation 1 and/or (ii) the comparison image computed in the operation 4. The suspect regions identified in operation 5 are preferably highlighted in the displayed report, and any suspect region annotations generated in operation 6 are preferably also shown in the displayed report.

In the method of FIG. 4, the operation 74 of scanning the tile image is assumed to employ optical carrier injection by two-photon absorption or other nonlinear optical interaction process(es) as described herein with reference to FIGS. 2 and 3. However, more generally, the operation 74 can alternatively employ optical carrier injection using linear absorption of the optical beam (rather than using nonlinear absorption process(es) as in the embodiments of FIGS. 2 and 3). For example, the operation 74 can scan the tile image using (by way of nonlimiting example) optical beam-induced current (OBIC) in which the photons are absorbed by conventional linear absorption. To achieve linear absorption of the light, such techniques would generally be performed with the photon energy of the optical beam being higher than the bandgap of the active layer. Furthermore, if the substrate has a bandgap that is smaller than or comparable to the bandgap of the active layer, then either the beam is applied to the frontside of the substrate so that it is not absorbed by the substrate, or the beam is applied from the backside of the substrate but with the substrate thinned or removed before scanning.

These imaging techniques employing linear absorption are still expected to benefit from the tile image acquisition approach of FIG. 4. In one benefit, the electronic beam steering is fast compared with scanning using only the mechanical translation stage, thereby providing faster image acquisition for the operations 1 and 2 of FIG. 1. In another benefit, the image tiles acquired using the electronic beam steering can often achieve higher spatial resolution than can be achieved by using the mechanical translation stage alone, due to limits on the tolerances of the mechanical translation mechanisms of the mechanical translation stage which limit the achievable spatial resolution.

In the validation approach of FIG. 1, it is assumed that there is a reference IC of the same IC technology and with the same circuitry with the same layout as is expected for the IC under test. Alternatively, there may be no reference IC, and instead the comparison may be with a reference layout, for example in GDSII file format. (That is, in FIG. 1, the acquisition 1 of the image of the reference IC could be replaced by providing a GDSII or other graphical reference layout).

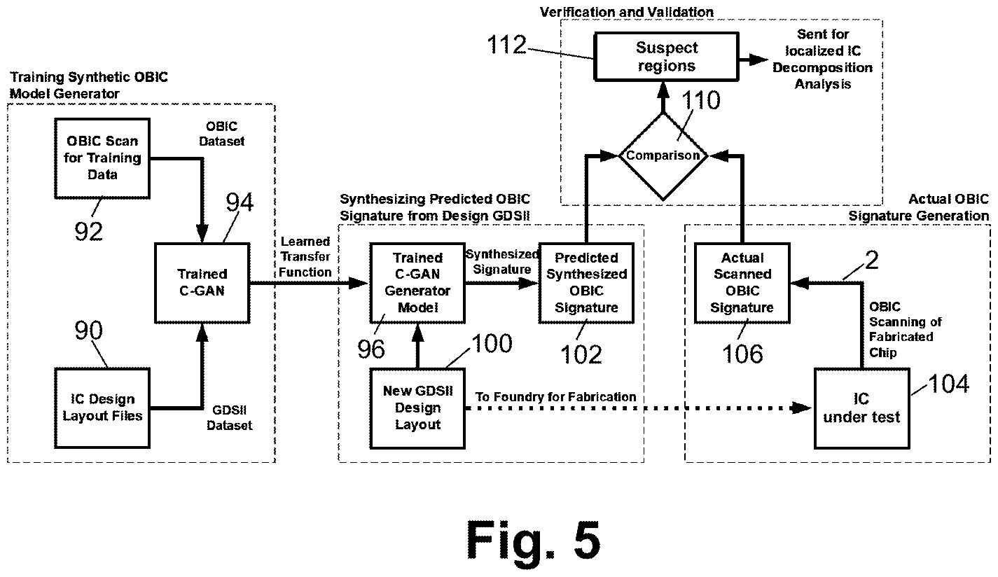

With reference to FIG. 5, another IC verification or validation approach is shown. The customer sends one or more IC fabrication orders to a foundry, using one or more (training) IC design layout files 90 employing the same IC technology as is used in the IC to be validated. The foundry returns the one or more fabricated ICs, which are used as one or more training ICs. While it cannot be assumed that these training ICs will agree precisely with the training IC layouts 90, it is reasonable to assume they will be at least close to being in accordance with the corresponding training IC layouts 90. These fabricated training ICs are imaged in an operation 92 using optical carrier injection, e.g. by way of nonlimiting illustrative example OBIC imaging using conventional linear absorption for the optical carrier injection or using nonlinear optical interaction achieved using the optical carrier injection device of FIGS. 2 and 3.

In an operation 94, a deep learning algorithm such as a Conditional Generative Adversarial Network (C-GAN) is used to train a model for translation of a GDSII layout to an OBIC image of an IC manufactured by the untrusted foundry in accordance with the GDSII layout. This training operation 94 uses as training data (i) the training IC layouts (e.g., training IC GDSII layouts) 90, and (ii) the images of the training ICs acquired at imaging operation 92. In one suitable approach for the C-GAN training 94, the GDSII layouts and OBIC images of the training ICs are aligned, split into 128×128 pixel (or otherwise-sized) sub-images, and the C-GAN is trained to convert a GDSII layout sub-images to corresponding training IC sub-images. To create a more robust model from relatively sparse amount of data for training, extra training data is optionally produced by rotating the sub-images at intervals of 90 degrees. A resulting trained C-GAN model (or other trained deep learning algorithm) 96 is thus generated. To evaluate the accuracy of the model, a test set of images can be drawn from the training IC layouts 90 and transformed, and the error then analyzed.

To validate ICs manufactured by the untrusted foundry for a new GDSII design layout (i.e. IC under test layout) 100, the IC under test layout 100 is input to the trained C-GAN 96 to generate a predicted OBIC image (i.e. signature) 102 for the IC under test layout 100. This predicted OBIC image 102 serves the same role as the image of the reference IC acquired at operation 1 of the validation method of FIG. 1. It should be noted that the new IC under test layout 100 (which may for example be a GSDII layout) may be the same as, or different from, the one or more training IC layouts 90 used in training the C-GAN 96.

The GSDII layout 100 is also supplied to the untrusted foundry, which duly fabricates ICs purportedly in accordance with the GSDII layout 100, thus producing the IC under test 104. The imaging operation 2 is then performed on the IC under test 104 as previously described with reference to FIG. 1. In the case of the validation approach of FIG. 5, the imaging operation 2 should use the same imaging system and the same or at least similar imaging parameters as those used in the imaging operation 92 that provided the training data for training 94 the C-GAN 96. Hence, in this illustrative example in which the imaging 92 was OBIC imaging, the imaging operation 2 should also employ OBIC imaging using conventional linear absorption for the optical carrier injection or using nonlinear optical interaction achieved using the optical carrier injection device of FIGS. 2 and 3 (whichever was used in the imaging 92). The imaging operation 2 produces the image 106 of the IC under test. In an operation 110 the image 106 of the IC under test is compared with the predicted OBIC image 102 output by the trained C-GAN 96 in response to the input of the new GDSII design layout 100. The operation 110 can operate analogously to the operations 3, 4, 5, 6, 7, 8, and 9 of FIG. 1, except that the image of the reference IC per FIG. 1 is replaced by the predicted OBIC image 102, and the regions identification 9 can be directly taken from the standard cells of the new GDSII design layout 100. In the illustrative embodiment of FIG. 5, the suspect regions 112 identified by the operation 110 (e.g., more particularly by the operation 5 of FIG. 1) may optionally be further analyzed by localized IC decomposition analysis, or otherwise further investigated.

While the illustrative example of FIG. 5 uses OBIC imaging, more generally the imaging operations 92 and 2 are performed by scanning an optical beam over the IC to optically inject carriers into the IC and measuring an output signal generated by the IC in response to the optical carrier injection. That output signal may be an electrical signal generated by the IC (e.g. as in OBIC imaging), or some other output generated by the IC in response to the optical carrier injection, or some computation based on an output or electrical response waveform from, or some computation based on output signal(s) and/or waveform (s).

The preferred embodiments have been illustrated and described. Obviously, modifications and alterations will occur to others upon reading and understanding the preceding detailed description. It is intended that the invention be construed as including all such modifications and alterations insofar as they come within the scope of the appended claims or the equivalents thereof.

1. An integrated circuit (IC) validation method comprising:
acquiring an image of an IC under test by scanning an optical beam over the IC under test to optically inject carriers into the IC under test and measuring an output signal comprising a value, a set of values, or a waveform at each pixel or voxel of the image generated by the IC under test in response to the optical carrier injection;
computing a comparison between the image of the IC under test and a reference image; and
identifying suspect regions of the IC under test based on the computed comparison.

2. The IC validation method of claim 1 further comprising:
acquiring an image of a reference IC by scanning the optical beam over the reference IC to optically inject carriers into the reference IC and measuring an output signal comprising a value, a set of values, or a waveform at each pixel or voxel generated by the reference IC in response to the optical carrier injection;
wherein the reference image comprises the image of the reference IC.

3. The IC validation method of claim 1 wherein the IC under test is fabricated in accordance with an IC under test layout, the method further comprising:
acquiring images of one or more training ICs fabricated in accordance with one or more training IC layouts by scanning the optical beam over the one or more training ICs to optically inject carriers into the one or more training ICs and measuring an output signal comprising a value, a set of values, or a waveform at each pixel or voxel generated by the one or more training ICs in response to the optical carrier injection;
training a deep learning algorithm to transform the one or more training IC layouts to the images of the one or more training ICs; and
transforming the IC under test layout using the trained deep learning algorithm to generate the reference image.

4. The IC validation method of claim 3 wherein the deep learning algorithm comprises a Conditional Generative Adversarial Network (C-GAN).

5. The IC validation method of claim 3 wherein the IC under test layout and the one or more training IC design layouts are GSDII layouts.

6. The IC validation method of claim 1 further comprising:
identifying regions depicting instances of standard cells in the reference image;
wherein the computing of the comparison comprises computing an error metric for each of the identified regions.

7. The IC validation method of claim 6 wherein the error metric comprises a mean squared error (MSE) or a structural similarity index measure (SSIM).

8. The IC validation method of claim 1 further comprising:
displaying the image of the IC under test on a display with the suspect regions highlighted in the displayed image of the IC under test.

9. The IC validation method of claim 1 wherein the IC validation method does not include thinning or removing a substrate of the IC under test.

10. The IC validation method of claim 1 wherein the optical beam comprises a pulsed optical beam having pulse duration of 900 femtoseconds or lower, and the acquiring of the image of the IC under test includes:
applying the pulsed optical beam on a backside of a substrate of the IC under test; and
focusing the pulsed optical beam at a focal point in an active layer disposed on a frontside of the substrate of the IC under test;
wherein a photon energy of the pulsed optical beam is lower than a bandgap of the substrate; and
wherein photons of the optical beam are absorbed at the focal point in the active layer of the IC under test by nonlinear optical interaction to inject carriers at the focal point in the active layer.

11. The IC validation method of claim 10 wherein the photon energy of the pulsed optical beam is lower than a bandgap of the active layer.

12. The IC validation method of claim 1 wherein the optical beam is a focused optical beam and the acquiring of the image of the IC under test includes:
sequentially mechanically positioning a focal point of the focused optical beam at coarse locations of a set of coarse locations in or on the IC under test;
with the focal point of the focused optical beam positioned at each coarse location, acquiring an image tile by steering the focal point of the focused optical beam to fine locations of a set of fine locations on or in the IC under test using electronic beam steering of the focused optical beam and, with the focal point of the focused optical beam positioned at each fine location, measuring the output signal generated by the IC under test in response to the optical carrier injection; and
using an electronic processor, stitching image tiles together to generate the image of the IC under test.

13. The IC validation method of claim 12 wherein the sequentially mechanical positioning of the focal point of the focused optical beam comprises translating the IC under test relative to the focal point of the focused optical beam using a mechanical translation stage on which the IC under test is disposed.

14. The imaging method of claim 12 wherein the electronic beam steering is performed using a galvo mirror, and an optical train including an f-theta scan lens and an objective are used to generate the focused optical beam.

15. An integrated circuit (IC) validation device comprising:
means for acquiring an image of an IC under test by scanning an optical beam over the IC under test to optically inject carriers into the IC under test and measuring an output signal comprising a value, a set of values, or a waveform at each pixel or voxel of the image generated by the IC under test in response to the optical carrier injection;
means for computing a comparison between the image of the IC under test and a reference image; and
means for identifying suspect regions of the IC under test based on the computed comparison.

16. An integrated circuit (IC) validation device comprising:
an optical carrier injection imaging system for acquiring an image of an IC under test, the optical carrier injection imaging system configured to scan an optical beam over an IC under test to optically inject carriers into the IC under test and to measure an output signal comprising a value, a set of values, or a waveform at each pixel or voxel of the image generated by the IC under test in response to the optical carrier injection;
an electronic processor programmed to compute a comparison image between the image of the IC under test and a reference image and to identify suspect regions of the IC under test based on the computed difference image; and
a display configured to present the suspect regions.

17. The IC validation device of claim 16 wherein:
the optical carrier injection imaging system is further configured to acquire an image of a reference IC by scanning the optical beam over the reference IC to optically inject carriers into the reference IC and measuring an output signal comprising a value, a set of values, or a waveform at each pixel or voxel generated by the reference IC in response to the optical carrier injection;
wherein the reference image comprises the image of the reference IC.

18. The IC validation device of claim 16 wherein the IC under test is fabricated in accordance with an IC under test layout, and wherein:
the optical carrier injection imaging system is further configured to acquire images of one or more training ICs fabricated in accordance with one or more training IC layouts by scanning the optical beam over the one or more training ICs to optically inject carriers into the one or more training ICs and measuring an output signal comprising a value, a set of values, or a waveform at each pixel or voxel generated by the one or more training ICs in response to the optical carrier injection; and
the electronic processor is further programmed to train a deep learning algorithm to transform the one or more training IC layouts to the images of the one or more training ICs, and to transform the IC under test layout using the trained deep learning algorithm to generate the reference image.

19. The IC validation device of claim 16 wherein optical carrier injection imaging system includes:
a positioning stage configured to hold the IC under test;
a laser configured to output the optical beam comprising a pulsed optical beam having pulse duration of 900 femtoseconds or lower;
an optical train arranged to focus the pulsed optical beam at a focal point in the IC under test to generate the output signal by absorption of the pulsed optical beam via nonlinear optical interaction at the focal point; and
a readout device comprising one or more of a voltmeter, an ammeter, or an ohmmeter configured to measure the output signal.

20. The IC validation device of claim 16 wherein the optical beam is a focused optical beam and wherein:
the optical carrier injection imaging system includes:
an optical train arranged to focus the optical beam at a focal point,
a translation stage configured to move the IC under test to sequentially place the focal point at coarse locations of a set of coarse locations in or on the IC under test, and
an electronic beam steering device configured to, with the focal point at each coarse location, steer the focal point to fine locations of a set of fine locations on or in the IC under test whereby the optical carrier injection system acquires an image tile at the coarse location; and
the electronic processor is programmed to stitch the image tiles together to generate the image of the IC under test.
